(19) United States
(12) Patent Application Publication
(10) Pub. No.: US 2003/0137571 A1
(43) Pub. Date: Jul. 24, 2003

(54) Recording element for ink jet printing

(76) Inventors: Horst Friedel, Neu Isenburg (DE); Marc Graindourze, Overpelt (BE); Stefaan Lingier, Assenede (BE); Huub Van Aert, Puldebos (BE)

Correspondence Address: Joseph T. Guy Ph. D., Nexsen Pruet Jacobs & Pollard LLP, 201 W. McBee Avenue, Greenville, SC, 29603, US

(21) Appl. No.: 10/342,703

(22) Filed: Nov. 27, 2002

Related U.S. Application Data
(60) Provisional application No. 60/351,314, filed on Jan. 23, 2002.

(51) Int. Cl. B41J 2/01

(52) U.S. Cl. 347/101

(57) ABSTRACT

An improved ink jet recording element is disclosed comprising, in order, a support, and, on at least one side of said support, a first ink receiving layer comprising a binder, a main ink-absorptive pigment, and pseudo-boehmite in an amount of 1 to 30% by weight versus said main pigment, and a second ink receiving layer having a haze value of at most 45%, and comprising a binder and a cationic substance consisting of particles with an average agglomerated particle size smaller than 500 nm.

### FIELD OF THE INVENTION

The present invention relates to an improved recording element for ink jet printing.

### BACKGROUND OF THE INVENTION

In the majority of applications printing proceeds by pressure contact of an ink-loaden printing form with an ink-receiving material which is usually plain paper. The most frequently used impact printing technique is known as lithographic printing based on the selective acceptance of oleophilic ink on a suitable receptor. In recent times however so-called non-impact printing systems have replaced classical pressure-contact printing to some extent for specific applications. A survey is given e.g. in the book “Principles of Non Impact Printing” by Jerome L. Johnson (1986), Palatino Press, Irvine, Calif. 92715, USA.

Among non-impact printing techniques ink jet printing has become a popular technique because of its simplicity, convenience and low cost. Especially in those instances where a limited edition of the printed matter is needed ink jet printing has become a technology of choice. A recent survey on progress and trends in ink jet printing technology is given by Hue P. Le in Journal of Imaging Science and Technology Vol. 42 (1), Jan/Febr 1998.

In ink jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink jet printers include U.S. Pat. Nos. 3,739,393, 3,805,273 and 3,891,121. The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image.

Alternatively, the charged deflected stream forms the image and the uncharged undeflected jet is recollected. In this variant of continuous ink jet printing several jets are deflected to a different degree and thus record the image (multideflection system). According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients: dyes or pigments, water and/or organic solvents, humectants such as glycols, detergents, thickeners, polymeric binders, preservatives, etc. . . It will be readily understood that the optimal composition of such an ink is dependent on the ink jetting method used and on the nature of the substrate to be printed. The ink compositions can be roughly divided in:

water based; the drying mechanism involves absorption, penetration and evaporation;

oil based; the drying involves absorption and penetration;

solvent based; the drying mechanism involves primarely evaporation;

hot melt or phase change: the ink vehicle is liquid at the ejection temperature but solid at room temperature; drying is replaced by solidification;

UV-curable; drying is replaced by polymerization.

It is known that the ink-receiving layers in ink-jet recording elements must meet different stringent requirements:

The ink-receiving layer should have a high ink absorbing capacity, so that the dots will not flow out and will not be expanded more than is necessary to obtain a high optical density.

The ink-receiving layer should have a high ink absorbing speed (short ink drying time) so that the ink droplets will not feather if smeared immediately after applying.

The ink dots that are applied to the ink-receiving layer should be substantially round in shape and smooth at their peripheries. The dot diameter must be constant and accurately controlled.

The receiving layer must be readily wetted so that there is no “puddling”, i.e. coalescence of adjacent ink dots, and an earlier absorbed ink drop should not show any “bleeding”, i.e. overlap with neighbouring or later placed dots.

Transparent ink-jet recording elements must have a low haze-value and be excellent in transmittance properties.

After being printed the image must have a good resistance regarding water-fastness, light-fastness, and good endurance under severe conditions of temperature and humidity.

The ink jet recording element may not show any curl or sticky behaviour if stacked before or after being printed.

The ink jet recording element must be able to move smoothly through different types of printers.

All these properties are often in a relation of trade-off. It is difficult to satisfy them all at the same time.

It is known that the presence in the ink accepting layer of absorptive pigments such as silica, kaolin, talc, aluminum oxide, boehmite, etc. improves the absorption capacity, the obtainable colour density and the drying time. Many patent applications have described this effect for many different binder-systems. U.S. Pat. No. 3,357,846 describes pigments such as kaolin, talc, bariet, TiO₂ used in starch and PVA. U.S. Pat. No. 3,889,270 describes silica in gelatin, PVA and cellulose. Pigments and particles have also been described in patent applications including DE 2,925,769, GB 2,050,866, U.S. Pat. Nos. 4,474,850, 4,547,405, 4,578,285, WO 88 06532, U.S. Pat. No. 4,849,286, EP 339604, EP 400681, EP 407881, EP 411638 and U.S. Pat. No. 5,045,864 (non-exhaustive list).

These particulates are dispersed in various types of binders of which the most common types are gelatin, polyvinyl alcohol, polyvinyl pyrrolidone, and various types of cellulose derivatives. These conventional binders are mentioned in numerous patent documents.

In EP 732219 a two-layer ink jet printing medium is disclosed comprising a liquid-absorbent base material, an ink receiving layer provided on the base material, which comprises a pigment, a binder, and a cationic substance, and a surface layer provided on the ink receiving layer comprising ultrafine cationic particles. Embodiments according to this teaching show improved glossiness and high optical density after printing. However, they need still further improvement for water-fastness, bleeding and color gamut. The present invention further extends the teachings on two-layer ink jet recording materials with improved properties.

### SUMMARY OF THE INVENTION

The present invention discloses an ink jet recording element comprising, in order, a support, and, on at least one side of said support,

(1) a first ink receiving layer comprising a binder, a main ink-absorptive pigment, and pseudo-boehmite in an amount of 1 to 30% by weight versus said main pigment, and,

(2) a second ink receiving layer having a haze value of at most 45%, and comprising a binder and a cationic substance consisting of particles with an average agglomerated particle size smaller than 500 nm.

In a preferred embodiment the main pigment is chosen from silica, aluminosilicate, alumina, calcium carbonate, alumina hydrate, and aluminum trihydroxide. Most preferred are aluminum containing pigments.

In the second ink receiving layer the cationic substance is preferably chosen from boehmite, cationized silica or mixtures thereof.

Both ink receiving layers can be coated on just one side of the support, or they can be present on both sides of the support, in which latter case the corresponding layers can show the same or a different composition.

In an alternative embodiment the second side of the support may carry one or more backing layers, different in composition from the definition of the ink receiving layers. The recording element may further comprise at least one adhesive undercoat layer.

Actual embodiments of ink jet recording media according to the present invention show improved water-fastness, bleeding drying time, color gamut properties, and reduced coalescence.

### DETAILED DESCRIPTION OF THE INVENTION

The composition and function of the different layers of the ink jet recording of the present invention will now be explained in more detail on the hand of their preferred embodiments.

The support for use in the present invention can be chosen from the paper type and polymeric type support well-known from photographic technology. Paper types include plain paper, cast coated paper, a paper carrying a barrier layer preventing ink penetration, polyethylene coated paper and polypropylene coated paper. Polymeric supports include cellulose acetate propionate or cellulose acetate butyrate, polyesters such as polyethylene terephthalate (PET) and polyethylene naphthalate, polyvinyl chloride, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. For transpartent materials polyester film supports, and especially polyethylene terephthalate, are preferred because of their excellent properties of dimensional stability. For the practice of the present invention a resin coated paper support is preferred.

In the present invention the support is coated with at least two ink receiving layers, called first and second ink receiving layers, which will be now explained successively in more detail. Preferably the first layer is a rather thick layer and can be regarded as the bulk ink receiving layer.

It is an essential feature of the present invention that the first ink receiving layer contains, apart from a binder and a main absorptive pigment, pseudo-boehmite in an amount of 1 to 30% by weight versus the main pigment.

The binder can be chosen from a list of compounds well-known in the art including hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinylacetal; polyvinyl pyrrolidone; polyacrylamide; acrylamide/acrylic acid copolymer; poly(styrene), styrene copolymers; acrylic or methacrylic polymers; styrene/acrylic copolymers; ethylene-vinylacetate copolymer; vinylmethyl ether/maleic acid copolymer; poly(2-acrylamido-2-methyl propane sulfonic acid); poly(diethylene triamine-co-adipic acid); polyvinyl pyridine; polyvinyl imidazole; polyimidazoline quaternized; polyethylene imine epichlorohydrin modified; polyethylene imine ethoxylated; poly(N,N-dimethyl-3,5-dimethylene piperidinium chloride; polyethylene oxide; polyurethane; melamine resins; gelatin; carrageenan; dextran; gum arabic; casein; pectin; albumin; starch; collagen derivatives; collodion and agar-agar

A preferred binder for the practice of the present invention is a polyvinylalcohol (PVA), a vinylalcohol copolymer or modified polyvinyl alcohol. Most preferably, the polyvinyl alcohol is a cationic type polyvinyl alcohol, such as the cationic polyvinyl alcohol grades from Kuraray, such as POVAL C506, POVAL C118, and from Nippon Goshei. Furthermore cationic polyvinyl alcohol may be obtained by several routes:

1) copolymerisation of vinyl acetate with a cationic monomer and subsequent hydrolysis. Preferred cationic monomers are quaternary ammonium salts or phosponium salts, such as methacryloxy ethyl trimethyl ammonium chloride, diallyl dimethylammonium chloride, ect. Examples of such copolymerisations are described in the following reference:

Functional modification of poly(vinyl alcohol) by copolymerization. III. Modification with cationic monomers. Moritani, Tohei; Yamauchi, Junnosuke. Technical Research Center, Kuraray Company, Okayama, Japan. Polymer (1998), 39(3), 559-572.

2) copolymerisation of a precursor for a cationic monomer with vinyl acetate and subsequent hydrolysis. Precursors for a cationic monomer include primary amines, secondary amines and tertairy amines, which become cationic after protonation, e.g. 2-(dimethylamino)ethyl methacrylate. Other precursors for cationic monomers are precursors for amino functional monomers such as vinyl acetamide. This route towards amino functional PVA is described in the following patents:

Manufacture of vinyl alcohol polymers by saponification. Fujiwara, Naoki; Sato, Kazuaki; Matsumoto, Yoichi; Nakahara, Fumio. (Kuraray Co., Ltd., Japan). JP-A 2001081128

Amine-functional poly(vinyl alcohol) for improving properties of recycled paper. Robeson, EP 617166

Preparation of cationic poly(vinyl alcohol). Noguchi, Yasunori; Kadota, Takashi. (Sakamoto Yakuhin Kogyo Co., Ltd., Japan). JP-A 03281607

Preparation of cationic derivatives of poly(vinyl alcohol). Stober, Reinhard; Kohn, Ellen; Bischoff, Dietmar. (Degussa A.-G., Fed. Rep. Ger.). DE 3626662 C1

3) Derivatization of polyvinylalcohol yielding amino, quaternary ammonium or quaternary phosphonium functional polymers, e.g. via esterification, etherification or acetalisation. Useful reagents for this purpose are e.g. 4-aminobutyraldehyde dimethyl acetal, aminoacetaldehyde, glycidyltrimethylammonium chloride, ect. Examples of such modifications are described in the following patents:

Paper wet-strength improvement with cellulose reactive size and amine-functional poly(vinyl alcohol) and paper from. Robeson, Lloyd M.; Davidowich, George; Pinschmidt, Robert K., Jr. (Air Products and Chemicals, Inc., USA). U.S. Pat. No. 5,397,436

Photographic film with improved light stability. Helling, Guenter; Peters, Manfred. (Agfa-Gevaert AG, Germany). Ger. Offen. (1996), DE 4438004 A1 19960502

Photographic recording material. Helling, Guenter; Dewanckele, Jean-Marie. (Agfa-Gevaert AG, Germany). EP 627656

4) An amino modified polyvinylalcohol prepared from a graft copolymerisation of amino-modified monomers with polyvinyl alcohol. The amino-functional monomer can have primairy, secondary, tertiary or quaternary amine groups. An example of a such graft copolymerisations is described by Celanese:

Ink receptive coating compositions containing poly(vinyl alcohol) grafted with amine functional groups. Rabasco, John Joseph; Klingenberg, Eric Howard; Boylan, John Richard. (Celanese International Corporation, USA). WO 01/74599

Graft polymers based on vinyl ester and/or alcohol polymers and ethylenically unsaturated monomers, their preparation and their use. Denzinger, Walter; Ruebenacker, Martin; Nilz, Claudia; Lorencak, Primoz; Moench, Dietmar; Schuhmacher, Rudolf; Stange, Andreas. (BASF AG., Germany). DE 19526626

The main pigment may be chosen from the inorganic pigments well-known in the art such as silica, talc, clay, hydrotalcite, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, boehmite (alumina hydrate), zirconium oxide or mixed oxides.

In a preferred embodiment the main pigment is chosen from silica, aluminosilicate, alumina, calcium carbonate, alumina hydrate, and aluminum trihydroxide.

The use of aluminum oxide (alumina) in ink receiving layers is disclosed in several patents, e.g. in U.S. Pat. Nos. 5,041,328, 5,182,175, 5,266,383, EP 218956, EP 835762 and EP 972650. Commercially available types of aluminum oxide (alumina) include α-Al₂O₃ types, such as NORTON E700, available from Saint-Gobain Ceramics & Plastics, Inc, γ-Al₂O₃ types, such as ALUMINUM OXID C from Degussa, Other Aluminum oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 tradeamrk from Cabot, CATALOX GRADES and CATAPAL GRADES from from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco. A useful type of alumina hydrate is γ-AlO(OH), also called boehmite, such as, in powder form, DISPERAL, DISPERAL HP14 and DISPERAL 40 from Sasol, MARTOXIN VPP2000-2 and GL-3 from Martinswerk GmbH.; Liguid boehmite alumina systems, e.g. DISPAL 23N4-20, DISPAL 14N-25, DISPERAL AL25 from Sasol. Patents on alumina hydrate include EP 500021, EP 634286, U.S. Pat. No. 5,624,428, EP 742108, U.S. Pat. No. 6,238,047, EP 622244, EP 810101, etc. . .

Useful aluminum trihydroxides include Bayerite, or α-Al(OH)₃, such as PLURAL BT, available from Sasol, and Gibbsite, or γ-Al(OH)₃, such as MARTINAL grades from Martinswerk GmbH, MARTIFIN grades, such as MARTIFIN OL104, MARTIFIN OL 107 and MARTIFIN OL111 from Martinswerk GmbH, MICRAL grades, such as MICRAL 1440, MICRAL 1500; MICRAL 632; MICRAL 855; MICRAL 916; MICRAL 932; MICRAL 932CM; MICRAL 9400 from JM Huber company; HIGILITE grades, e.g. HIGILITE H42 or HIGILITE H43M from Showa Denka K.K., HYDRAL GRADES such as HYDRAL COAT 2, HYDRAL COAT 5 and HYDRAL COAT 7, HYDRAL 710 and HYDRAL PGA, from Alcoa Industrial Chemicals.

A useful type of zirconium oxide is NALCO OOSS008 trademark of ONDEO Nalco, acetate stabilized ZrO2, ZR20/20, ZR50/20, ZR100/20 and ZRYS4 trademarks from Nyacol Nano Technologies.

Useful mixed oxides are SIRAL grades from Sasol, colloidal metaloxides from Nalco such as Nalco 1056, Nalco TX10496, Nalco TX11678.

Silica as pigment in ink receiving elements is disclosed in numerous old and recent patents, e.g. U.S. Pat. Nos. 4,892,591, 4,902,568, EP 373573, EP 423829, EP 487350, EP 493100, EP 514633, etc. . . Different types of silica may be used, such as crystalline silica, amorphous silica, precipitated silica, gel silica, colloidal silica, fumed silica, spherical and non-spherical silica, calcium carbonate compounded silica such as disclosed in U.S. Pat. No. 5,281,467, and silica with internal porosity such as disclosed in WO 00/02734.

The use of calcium carbonate in ink receiving layers is described in e.g. DE 2925769 and U.S. Pat. No. 5,185,213. The use of alumino-silicate is disclosed in e.g. DE 2925769.

Mixtures of different pigments may be used.

In an alternative embodiment the main pigment can be chosen from organic particles such as polystyrene, polymethyl methacrylate, silicones, melamine-formaldehyde condensation polymers, urea-formaldehyde condensation polymers, polyesters and polyamides. Mixtures of inorganic and organic pigments can be used.

As stated above it is essential to the present invention that the first ink receiving layer further contains pseudo-boehmite in an amount between 1 and 30% by weight vis-á-vis the main pigment. Pseudo-boehmite is also called boehmite gel and is fine particulate alumina hydrate having a needle form. The composition thereof is generally represented by Al₂O₃.1.5-2 H₂O and differs from that of crystalline boehmite.

The incorporation of pseudo-boehmite in the first ink receiving layer brings the following surprising advantages for the ink jet recording medium: improvements for water-fastness and bleeding, and reduced coalescence.

The lower limit of the ratio by weight of the binder to the total pigment in the first ink receiving layer is preferably about 1:50, most preferably 1:20, while the upper limit thereof is about 2:1, most preferably 1:1. If the amount of the pigment exceeds the upper limit, the strength of the ink receiving layer itself is lowered, and the resulting image hence tends to deteriorate in rub-off resistance and the like. On the other hand, if the binder to pigment ratio is too great, the ink-absorbing capacity of the resulting ink-receiving layer is reduced, and so the image formed may possibly be deteriorated.

It is a further essential feature of the present invention that the second ink receiving layer is a layer having a haze value of at most 45% and that it contains a cationic substance consisting of particles with an average agglomerated particle size smaller than 500 nm.

The term “cationic substance” as used in the present invention means a substance composed of fine particles having a positive charge on their surfaces and therefore having adsorbability of acid substances such as acid dyes. Specific examples thereof include fine particles composed of oxides of metals such as magnesium, calcium, aluminum, zirconium, zinc, chromium, iron, copper, tin, lead and manganese. Those having a negative charge on their surfaces like silica may also be used if they are surface-treated to change the negative charge on the surface to a positive charge. Preferably the cationic substance is chosen from crystalline boehmite and cationized silica, and mixtures thereof. Boehmite is explained above. Examples of the fine particles of cationized silica include:

(1) silica subjected to a surface treatment with a compound containing some of the cationic metal oxides or metal atoms as described above; an example of such preparation route is described in the following reference:

Cationic silica dispersion for recording material. Field, Rex J.; Darsillo, Michael S.; Fluck, David J.; Laufhutte, Rudiger. (Cabot Corporation, USA). WO 00/20221

Recording medium excellent in ink absorptivity and process for its production, and process for producing silica-alumina composite sol. Nakahara, Katsumasa; Inokuma, Hisao; Hirano, Hachirou; Matsubara, Toshiya; Wakabayashi, Masako; Kon, Yoshinori. (Asahi Glass Company Ltd., Japan). EP 1112962 A1

Ink-receptive coating for ink-jet recording material. Chapman, David Monroe. (W. R. Grace & Co.-Conn., USA). WO 00/02736

(2) silica subjected to a surface treatment with an organic compound having both amino group or quaternary ammonium group thereof and functional group having reactivity to a silanol group on the surface of silica, such as aminoethoxysilane or aminoalkyl glycidyl ether or isopropanol amine, examples of such preparation routes are described in:

Ink-jet printing ink-accepting compositions comprising cation-modified silica, vinyl polymers and cationic polymers for printing fabrics using ink-jet printers with high color depth and printing fabrics coated or impregnated with the compositions. Yasuda, Masahiro; Okudo, Toshifumi; Hirota, Yasuhide. (Kyoeisha Chemical Co., Ltd., Japan). JP-A 2000265380

Ink-jet-printable image-transfer medium, process for transferring image, and cloth imaged by this process. Sato, Yuko; Higuma, Masahiko; Shino, Yoshiyuki. (Canon Kabushiki Kaisha, Japan). EP 933225 A1

Adsorption of cationic surfactants on highly dispersed silica. Mikhailova, I. V.; Gerashchenko, I. I. Institute of Surface Chemistry, National Academy of Sciences of Ukraine, Kiev, Ukraine. Colloid J. (2001), 63(4), 437-440.

Functionalization of silica particles towards cationic polyelectrolytes using vinylformamide and 1,3-divinylimidazolidin-2-one as monomers. Meyer, Torsten; Rehak, Petra; Jager, Christian; Voigt, Ina; Simon, Frank; Spange, Stefan. Polymer Chemistry, Institute for Chemistry, Chemnitz University of Technology, Chemnitz, Germany. Macromol. Symp. (2001), 163 (Tailormade Polymers), 87-96.

Image receiving element and method of manufacturing the element. Yarmey, Susan K.; Steiner, Michael L. (Imation Corp., USA). WO 01/05599

Coated paper with good printability for ink-jet printing. Hirose, Mifune; Sakaki, Mamoru; Katayama, Masato; Higuma, Masahiko; Moriya, Kenichi; Nishioka, Yuko. (Canon K. K., Japan). EP 732219 A2

Manufacture of porous, laminar, inorganic products. Yokoyama, Masaru; Hirao, Shozo; Kishimoto, Takashi; Takahama, Koichi. (Matsushita Electric Works, Ltd., Japan). JP-A 62176969

(3) polymerisation of a cationic or amino functional monomer in the presence of a silica, e.g. as descibed in:

Ink-jet printing sheet containing cationic silica. Ito, Hiroshi; Sawamoto, Hidetada; Hasegawa, Makoto. (Oji Paper Co., Ltd., Japan). JP-A 2001293948

Grafting of polymers with controlled molecular weight onto carbon black and ultrafine silica surface. Tsubokawa, Norio; Yoshikawa, Sachio. Department of Material Science and Technology, Faculty of Engineering, Niigata University, Niigata, Japan. Recent Res. Dev. Polym. Sci. (1998), 2(Pt. 2), 211-228.

Cationic polymer synthesis at inorganic surfaces. Spange, S. Inst. Org. Chem. Macromol. Chem., Jena Univ., Jena, Germany. Vysokomol. Soedin., Ser. A Ser. B (1993), 35(11), 1873-7.

In a particular preferred embodiment the upper ink receiving layer contains also a minor amount of pseudo-boehmite in an amount preferably comprised between 0.5 and 20% versus the cationic substance.

The binder of the upper ink receiving layer can be chosen from the list described for the lower ink receiving layer. The ratio by weight of particles to binder in the upper layer is preferably comprised between 1:60 and 2:1

The thickness of the upper ink receiving layer is preferably smaller than the thickness of the first layer (bulk layer). The dry thickness of the upper ink receiving layer is preferably comprised between 10 and 40% vis-á-vis the dry thickness of the bulk layer. The advantages of the presence of the second ink receiving layer and its particular composition are: improved density of colors, improved color gamut, and lack of coalescence.

The first and second ink receiving layers may be coated on just one side of the support, or they may be applied on both sides of the support. In the latter case the corresponding layers on both sides may be exactly the same, or they may be different, as long as their composition obeys the defintions given. For instance the first layer on one side may contain another main pigment than the first layer on the other side, or the two upper layers may contain a different cationic substance.

Furtheron, an extra adhesive undercoat layer may be incorporated, on one or both sides of the support, between the support and the first ink receiving layer. This layer is then coated from an aqueous medium containing any of the numerous known adhesive polymers. Preferred adhesive polymers include styrene-butadiene latex, acrylate latices, poly(ethylene-vinylacetate), polyvinylesters, copolyesters, polyesters and polyurethanes. Furhermore, the adhesive polymers include WAC series, such as WAC-10, WAC-15, WAC-17X and WAC-20, trademarks of Takamatsu Oil & Fat Co. The dry coating weight of this undercoat layer when present is preferably comprised between 0.5 and 5.0 g/m².

In still another alternative embodiment the first and second ink receiving layers may be present on one side of the support, and the other side is coated with at least one backing layer different in composition from the definitions given for the ink receiving layers. The function of this layer may be, for instance, promotion of transport in printers, or control of the curling of the recording medium. This backing layer(s) may contain binders, matting agents, surfactants, plasticizers, etc. . .

Apart from the essential ingredients described above a cationic substance acting as mordant may be present in one or both ink receiving layer. Such substances increase the capacity of the layer for fixing and holding the dye of the ink droplets. A particularly suited compound is a poly(diallyldimethylammonium chloride) or, in short, a poly(DADMAC). These compounds are commercially available from several companies, e.g. Aldrich, Nalco, CIBA, Nitto Boseki Co., Clariant, BASF and EKA Chemicals.

Other useful cationic compounds include DADMAC copolymers such as copolymers with acrylamide, e.g NALCO 1470 trade mark of ONDEO Nalco or PAS-J-81, trademark of Nitto Boseki Co., such as copolymers of DADMAC with acrylates, such as Nalco 8190, trademark of ONDEO Nalco; copolymers of DADMAC with SO₂, such as PAS-A-1 or PAS-92, trademarks of Nitto Boseki Co., copolymer of DADMAC with maleic acid, e.g. PAS-410, trademark of Nitto Boseki Co., copolymer of DADMAC with diallyl(3-chloro-2-hydroxypropyl)amine hydrochloride, eg. PAS-880, trademark of Nitto Boseki Co., dimethylamine-epichlorohydrine copolymers, e.g. Nalco 7135, trademark of ONDEO Nalco or POLYFIX 700, trade name of Showa High Polymer Co.; other POLYFIX grades which could be used are POLYFIX 601, POLYFIX 301, POLYFIX 301A, POLYFIX 250WS, and POLYFIX 3000; NEOFIX E-117, trade name of Nicca Chemical Co., a polyoxyalkylene polyamine dicyanodiamine, and REDIFLOC 4150, trade name of EKA Chemicals, a polyamine; MADAME (methacrylatedimethylaminoethyl=dimethylaminoethyl methacrylate) or MADQUAT (methacryloxyethyltrimethylammonium chloride) modified 4739L, PLEX 3073 from Rohm, DIAFLOC KP155 and other DIAFLOC products from Diafloc Co., and BMB 1305 and other BMB products from EKA chemicals; cationic epichlorohydrin adducts such as POLYCUP 171 and POLYCUP 172, trade names from Hercules Co.; from Cytec industries CYPRO products, e.g. CYPRO 514/515/516, SUPERFLOC 507/521/567; cationic acrylic polymers, such as ALCOSTAT 567, trademark of CIBA, cationic cellulose derivatives such as CELQUAT L-200, H-1OO, SC-240C, SC-230M, trade names of Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LUPASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; phosphonium compounds such as disclosed in EP 609930 and other cationic polymers such as NEOFIX RD-5, trademark of Nicca Chemical Co.

The ink receiving layer and the optional supplementary layers may further contain well-known conventional ingredients, such as surfactants serving as coating aids, hardening agents, plasticizers, whitening agents and matting agents.

Surfactants may be incorporated in the layers of the recording element of the present invention. They can be any of the cationic, anionic, amphoteric, and non-ionic ones as described in JP-A 62-280068 (1987). Examples of the surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfonic acid salts, sulfonated oils, alkylsulfonic acid salts, alkylether sulfonic acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulfonyl glutamate, sodium 3-(fluoro-C₆-C₁₁-alkyloxy)-1-C₃-C₄ alkyl sulfonates, sodium 3-(ω-fluoro-C₆-C₈-alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids, perfluoro-C₇-C₁₃-alkyl-carboxylic acids, perfluorooctane sulfonic acid diethanolamide, Li, K and Na perfluoro-C₄-C₁₂-alkyl sulfonates, N-propyl-N-(2-hydroxyethyl)perfluorooctane sulfonamide, perfluoro-C₆-C₁₀-alkylsulfonamide-propyl-sulfonyl-glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-dimoniumchloride phosphate, palmityl trimethylammonium chloride, and cetyltrimethylammonium bromide.

Especially useful are the fluorocarbon surfactants as described in e.g. U.S. Pat. No. 4,781,985, having a structure of: F(CF₂)₄₋₉CH₂CH₂SCH₂CH₂N⁺R₃X⁻ wherein R is a hydrogen or an alkyl group; and in U.S. Pat. No. 5,084,340, having a structure of: CF₃(CF₂)ₘCH₂CH₂O(CH₂CH₂O)ₙR wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2%, preferably in the range of 0.4 to 1.5% and is most preferably 0.75% by weight based on the total dry weight of the layer.

The ink-receiving layers and the optional backing and/or adhesive layers according to this invention may be crosslinked to provide such desired features as waterfastness and non-blocking characteristics. The crosslinking is also useful in providing abrasion resistance and resistance to the formation of fingerprints on the element as a result of handling. There are a vast number of known crosslinking agents—also known as hardening agents—that will function to crosslink film forming binders. Hardening agents can be used individually or in combination and in free or in blocked form. A great many hardeners, useful for the present invention, are known, including formaldehyde and free dialdehydes, such as succinaldehyde and glutaraldehyde, blocked dialdehydes, active esters, sulfonate esters, active halogen compounds, isocyanate or blocked isocyanates, polyfunctional isocyanates, melamine derivatives, s-triazines and diazines, epoxides, active olefins having two or more active bonds, carbodiimides, zirconium complexes, e.g. BACOTE 20, ZIRMEL 1000 or zirconium acetate, trademarks of MEL Chemicals, titanium complexes, such as TYZOR grades from DuPont, isoxazolium salts subsituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches and copoly(acroleinmethacrylic acid), and oxazoline functional polymers, e.g. EPOCROS WS-500, and EPOCROS K-1000 series, and maleic anhydride copolymers, e.g. GANTREZ AN119 In the practice of this invention boric acid is a preferred crosslinker.

The ink-receiving layers and the optional supplementary layers of the present invention may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, a coating weight of 35 g/sqm aluminum oxide next to the PE layer, and B1 with a coating weight of 5 g/sqm boehmite on top of the aluminum oxide layer. The coating was dried at 50° C. The sample was named D1.

Six other coating compositions were prepared in the same manner as

1-A1 but with the following modifications:

1-A2: A1 plus 5 parts of commercial pseudo-boehmite DISPERAL P3, trade name of Sasol Co., 15% dispersion in water;

1-A3: A1 plus 10 parts of DISPERAL P3;

1-A4: A1 plus 15 parts of DISPERAL P3;

1-A5: A1 plus 20 parts of DISPERAL P3;

1-A6: a coating composition made of 50 parts of aluminum oxide CAB-O-SPERSE PG003, 50 parts of fumed silica (OX 50 from Degussa), 10 parts of pseudo-boehmite DISPERAL P3, 6.5 parts of a polyvinyl alcohol from Nippon Goshei Co., and 0.65 parts of boric acid; OX 50 and DISPERAL P3 were dispersed together in water; the silica concentration was 25%.

1-A7: a coating composition made of 100 parts of silica (OX 50 from Degussa), 20 parts of pseudo-boehmite DISPERAL P3, 6.5 parts of a polyvinyl alcohol from Nippon Goshei Co., and 0.65 parts of boric acid; OX 50 and DISPERAL P3 were dispersed together in water; the silica concentration was 25%.

The coating compositions 1-A1 to 1-A7 were coated with a cascade coater together with 1-B1 in a 2-layer wet on wet coating process. The coating weight of 1-A2 to 1-A7 was 35 g/sqm of aluminum oxide, or aluminum oxide/silica, or silica. The coating weight of top layer 1-B1 was 5 g/sqm of boehmite. The samples were named 1-D2 to 1-D7.

The materials 1-D1 to 1-D7 were printed with a test pattern on EPSON 740, LEXMARK Z52 and HP 895 narrow format printers. The materials were evaluated qualitatively for following four characteristics by means of an arbitrary scale:

(a) drying time:

1=less than 5 seconds;

2=5-10 seconds;

3=10-20 seconds;

4=30 seconds or more;

(b) coalescence (forming of large drops on the media):

1=no coalescence;

2=coalescence in secondary colors (200% ink or more);

3=coalescence in primary colors;

4=full coalescence;

(c) water-fastness:

1=no smear off from colors when rubbing over wet layer;

2=some black color smear off;

3=some other colors smear off;

4=all colors and layer smear off;

(d) bleeding of printed and dried colors (bleeding of dyes from CMYK 400% ink into white lines next to the printed area):

1=no bleeding;

2=bleeding visible by microscope;

3=bleeding to be seen by eye;

4=total filling of 1 mm lines.

The results are summarized in following table 1.

TABLE 1

| Sample No | Drying time | Coalescence | Water-fastness | Bleeding |
|---|---|---|---|---|
| 1-D1 | 1 | 1 | 3 | 4 |
| 1-D2 | 1 | 1 | 3 | 3 |
| 1-D3 | 1 | 1 | 2 | 3 |
| 1-D4 | 1 | 1 | 2 | 2 |
| 1-D5 | 2 | 2 | 1 | 1 |
| 1-D6 | 1 | 1 | 2 | 2 |
| 1-D7 | 2 | 2 | 1 | 1 |

The results of table 1 clearly show the influence of the presence of pseudo-boehmite in the bottom layer for water-fastness and bleeding of the printed area. The concentration goes through an optimum value. At the highest level (20% of pseudo-boehmite) drying time and coalescence become worse. The findings are true for each case when using alumina, or silica, or mixtures of both as the main pigment.

### EXAMPLE 2

In this example the influence of pseudo-boehmite as co-pigment in a top layer mainly comprising boehmite will now be illustrated.

A coating composition (2-A1) was prepared containing:

100 parts of of the commercial aluminum oxide CAB-O-SPERSE PG003, trade name of Cabot Co., a 40% dispersion in water,

10 parts of DISPERAL P3, pseudo-boehmite from Sasol, 15% dispersion in water,

6.5 parts of a polyvinyl alcohol from Nippon Goshei Co., 10% solution in water,

and 0.65 parts of boric acid.

A second coating composition (2-B1, identical to 1-B1) was prepared containing:

100 parts of the commercial boehmite DISPERAL HP 14/2, from Sasol Co., a 25% dispersion in water,

2 parts of a polyvinyl alcohol from Nippon Goshei Co.,

and 0.2 parts of boric acid.

Four other coatings 2-B2 to 2-B5 were prepared in the same way as 2-B1 but with the following modifications:

2-B2: 2-B1 plus 2 parts of DISPERAL P3, pseudo-boehmite from Sasol,

15% dispersion in water;

2-B3: 2-B1 plus 4 parts of DISPERAL P3;

2-B4: 2-B1 plus 8 parts of DISPERAL P3;

2-B5: 2-B1 plus 16 parts of DISPERAL P3.

Five coatings 2-D1 to 2-D5 were made with a cascade coater in a two-layer wet on wet coating process on a polyethylene coated paper, 2-A1 with a coating weight of 35 g/sqm aluminum oxide next to the PE layer, and 2-B1 to 2-B5 with a coating weight of 5 g/sqm of boehmite on top of the of layer 2-A1. The coatings were dried at 50° C. They were named 2-D1 to 2-D5.

The five materials were printed with a test pattern on EPSON 740, LEXMARK Z52, and HP 895 narrow format printers. The materials were evaluated in the same way as the samples of Example 1. The results are summarized in following table 2.

TABLE 2

| Sample No | Drying time | Coalescence | Water-fastness | Bleeding |
|---|---|---|---|---|
| 2-D1 | 1 | 1 | 2 | 3 |
| 2-D2 | 1 | 1 | 2 | 2 |
| 2-D3 | 1 | 1 | 1 | 1 |
| 2-D4 | 2 | 2 | 2 | 1 |
| 2-D5 | 3 | 3 | 2 | 1 |

The results of table 2 clearly demonstrate the favourable effect of increasing concentrations of pseudo-boehmite in a boehmite containing layer on top of a pigment/pseudo-boehmite layer for bleeding of printed and dried media. At high levels of pseudo-boehmite (>5%) in the top layer coalescence and drying time become worse. So there is an optimal ratio of amount boehmite to amount of pseudo-boehmite in that top layer.

### EXAMPLE 3

In a third group of experiments the pseudo-boehmite in the bulk and top layer were replaced by cationic organic polymers in order to demonstrate the advantage of using pseudo-boemite.

The following coating composition (3-A1) was prepared:

100 parts of of the commercial aluminum oxide CAB-O-SPERSE PG003, trade name of Cabot Co., a 40% dispersion in water,

6.5 parts of a polyvinyl alcohol from Nippon Goshei Co., 10% solution in water,

and 0.65 parts of boric acid.

Four other coating compositions 3-A2 to 3-A5 were prepared in the same way as 3-A1 but with the following modifications:

3-A2: 3-A1 plus 1 part of POLYFIX 301A (from Showa High Polymer, Japan);

3-A3: 3-A1 plus 1 part of POLYFIX 250 WS (from Showa High Polymer, Japan);

3-A4: 3-A1 plus 1 part of NEOFIX 117 (from Nicca Chemical Co., Japan);

3-A5: 3-A1 plus 1 part of CAT FLOC L (from ONDEO Nalco).

A further coating composition 3-B1 was prepared containing

100 parts of the commercial boehmite DISPERAL HP 14/2, from Sasol Co., a 25% dispersion in water,

2 parts of a polyvinyl alcohol from Nippon Goshei Co.,

and 0.2 parts of boric acid.

Four other coating compositions 3-B2 to 3-B5 were prepared in the same way as 3-B1 but with the following modifications:

3-B2: 3-B1 plus 1 part of POLYFIX 301A (from Showa High Polymer, Japan);

3-B3: 3-B1 plus 1 part of POLYFIX 250 WS (from Showa High Polymer, Japan);

3-B4: 3-B1 plus 1 part of NEOFIX 117 (from Nicca Chemical Co., Japan);

3-B5: 3-B1 plus 1 part of CAT FLOC L (from ONDEO Nalco Co.,).

Five coatings 3-D1 to 3-D5 were made with a cascade coater in a 2-layer wet on wet coating process on PE coated paper, 3-A1 to 3-A5 with a coating weight of 35 g/sqm aluminum oxide next to the PE layer, and 3-B1 to 3-B5 with a coating weight of 5 g/sqm boehmite on top of each corresponding aluminum oxide layer. The coatings were dried at 50° C.

The materials 3-D1 to 3-D5 were printed with a test pattern on EPSON 740, LEXMARK Z52 and HP 895 narrow format printers. The materials were evaluated as in the previous examples. The results are summarized in following table 3.

TABLE 3

| Sample No | Drying time | Coalescence | Water-fastness | Bleeding |
|---|---|---|---|---|
| 3-D1 | 1 | 1 | 3 | 4 |
| 3-D2 | 1 | 2 | 2 | 3 |
| 3-D3 | 1 | 2 | 3 | 3 |
| 3-D4 | 1 | 2 | 3 | 2 |
| 3-D5 | 1 | 3 | 2 | 2 |

The results of table 3 demonstrate that the use of cationic polymers in the bulk and the top layer improves the bleeding but at the same time the coalescence becomes worse. Therefore the presence of pseudo-boehmite in a boehmite layer to suppress bleeding of printed and dried media to avoid coalescence is favourable.

Having described in detail preferred embodiments of the current invention, it will now be apparent to those skilled in the art that numerous modifications can be made therein without departing from the scope of the invention as defined in the appending claims.

1. An ink jet recording element comprising, in order, a support, and, on at least one side of said support,
(1) a first ink receiving layer comprising a binder, a main ink-absorptive pigment, and pseudo-boehmite in an amount of 1 to 30% by weight versus said main pigment, and,
(2) a second ink receiving layer having a haze value of at most 45%, and comprising a binder and a cationic substance consisting of particles with an average agglomerated particle size smaller than 500 nm.

2. An ink jet recording element according to claim 1 wherein said cationic substance is chosen from the group consisting of boehmite, cationized silica, and mixtures thereof.

3. An ink jet recording element according to claim 1 wherein said main pigment in said first ink receiving layer is chosen from the group consisting of silica, aluminosilicate, alumina, calcium carbonate, alumina hydrate, aluminum trihydroxide, or mixtures thereof.

4. An ink jet recording element according to claim 1 wherein said main pigment in said first ink receiving layer is an organic pigment.

5. An ink jet recording element according to claim 1 wherein said second ink receiving layer further also comprises pseudo-boehmite.

6. An ink jet recording element according to claim 5 wherein said pseudo-boehmite is present in said second ink receiving layer in an amount from 0.5 to 20% versus said cationic substance.

7. An ink jet recording element according to claim 1 wherein the dry thickness of said second ink receiving layer (2) is comprised between 10 and 40% vis-á-vis the dry thickness of said first ink receiving layer (1).

8. An ink jet recording element according to claim 1 wherein the binder of said layers (1) and/or (2) is a polyvinyl alcohol.

9. An ink jet recording element according to claim 8 wherein said polyvinyl alcohol is a cationic polyvinyl alcohol.

10. An ink jet recording element according to claim 1 wherein said layer (1) and/or said layer (2) further contains a hardening agent.

11. An ink jet recording element according to claim 10 wherein said hardening agent is boric acid.

12. An ink jet recording element according to claim 1 wherein said support is a transparent support.

13. An ink jet recording element according to claim 12 wherein said transparent support is a polyester support.

14. An ink jet recording element according to claim 1 wherein said support is a resin coated paper.

15. An ink jet recording element according to claim 1 wherein both sides of the support carry first and second ink receiving layers as defined in claim 1, whereby the corresponding layers on both sides can have the same or a different composition.

16. An ink jet recording element according to claim 1 wherein just one side of the support carries first and second ink receiving layers as defined in claim 1, and the other side carries at least one backing layer different from said ink receiving layers.

17. An ink jet recording element according to claim 16 wherein said at least one backing layer contains a matting agent.

18. An ink jet recording element according to claim 1 wherein said element further comprises, on one or on both sides of the support, an extra adhesive undercoat layer, incorporated between the support and the first ink receiving layer.

19. An ink receiving layer according to claim 18 wherein said adhesive undercoat layer contains an adhesive polymer latex.
